(19) United States
(12) Patent Application Publication
(10) Pub. No.: US 2016/0302399 A1
(43) Pub. Date: Oct. 20, 2016

(54) FISHING HOOK FOR HOOKING LIVE BAIT

(71) Applicants: Demetrios Sakellaropoulos, Succasunna, NJ (US); Bobby Kasolas, Riverdale, NJ (US)

(72) Inventors: Demetrios Sakellaropoulos, Succasunna, NJ (US); Bobby Kasolas, Riverdale, NJ (US)

(21) Appl. No.: 14/687,708

(22) Filed: Apr. 15, 2015

(51) Int. Cl. A01K 83/06; A01K 97/00; A01K 99/00

(52) U.S. Cl. CPC A01K 83/06; A01K 99/00; A01K 97/00

(57) ABSTRACT

The described invention provides a fishhook for nostril-hooked live bait-fish and a method for reducing injury to a nostril-hooked live bait-fish. The described fishhook comprises a point, a bend, a shank, an eye to secure the fishhook onto a fishing line, and a barrier structure. The point is a sharp end that penetrates the bait-fish's mouth or flesh, the bend is a curved portion of the fishhook that extends downwards from the point and then upwards towards the shank, and the barrier structure is fixedly placed at a point along the bend of the fishhook. The fixedly placed barrier structure is effective to reduce injury to the bait-fish from a fishhook point when the bait-fish swims or moves while attached to the fishhook.

### FIELD OF INVENTION

The described invention generally relates generally to fishing hooks for live bait-fish.

### BACKGROUND OF THE INVENTION

A fish hook (or fishhook) is a device for impaling a live fish in its natural aquatic environment. Fish hooks are designed to hold various types of artificial, processed, dead or live baits (bait-fishing); to act as the foundation for artificial representations of fish prey (fly fishing); or to be attached to or integrated into other devices that represent fish prey (lure fishing). Within these broad categories there are wide varieties of hook types designed to catch different size fish.

For successful fishing, a fish hook that is appropriate for the particular goal(s) of the fishing endeavor is needed. Depending on the intended application(s), fishhooks of different sizes, designs, shapes, materials (e.g. metal or nonmetal), coatings and other variables may be available from which to choose. Contemporary hooks are manufactured from high-carbon steel, steel alloyed with Vanadium, or stainless steel, depending on the application. Most quality fish hooks are covered with some form of corrosion-resistant surface coating. Corrosion resistance is required not only when hooks are used, especially in saltwater, but while they are stored. Additionally, coatings are applied to color and/or provide aesthetic value to the fishhook. For example, some fishhooks for freshwater use are coated with a clear lacquer, while other fishhooks also may be coated with gold, nickel, Teflon, tin as well as different colors. When fishing, a fishhook should be proportioned according to the size of the targeted fish and to the size of the bait. If a hook is too big, a live bait-fish will not swim naturally in the water and will attract fewer strikes.

Many factors contribute to bait hook design, including corrosion resistance, weight, strength, hooking efficiency, and whether the hook is being used for specific types of bait. For each hook type, there are ranges of acceptable sizes, e.g., from 0.01563 inches (size 01) to 77 mm (2.95275 in., size 64).

Additional parameters include shank length (e.g., short, standard, extra long, 2XL, etc.), wire size (e.g., fine, extra heavy, 2X heavy, etc.), and thickness. For example, a bait hook is normally made of thin wire to reduce injury to live bait in order to attract game fish. The term “to reduce” as used herein refer to a diminution, a decrease, an attenuation or abatement of the degree, intensity, extent, size, amount, density or number of. The term “injury” as used herein refers to damage or harm to a structure or function of the body of the bait-fish caused by an outside agent or force, which may be physical.

Fishhooks can have a number of added features. For example, while some fishhooks are made with multiple points, barbs and bends, others are barbless to make hook removal and fish release less stressful on the fish. The extent to which the fishhook point is offset from the hook shank is yet another variable. For example, a kirbed hook point is offset to the left, a straight point has no offset and a reversed point is offset to the right. In addition, the shape of the hook shank can vary widely from straight to many types of curves, kinks, bends and offsets. These different shapes contribute in some cases to better hook penetration or bait holding ability.

The term “bait” as used herein is used to describe anything attached to the fish hook to assist in catching fish. Bait can be alive, dead or made from some inanimate material like rubber or plastic. The type of bait and means by which the bait is placed on the fishhook (referred to as “baiting the hook” or BTH) can affect the success of catching a fish. The process of immobilizing the bait on the fish hook involves pushing the point of the fish hook through the bait and, after the point has penetrated the bait, pushing the hook further through the bait until the bait resides at the desired location on the hook. An exemplary desired location is near the lowest point on the bend of the fishhook, also referred to as the trough of the fishhook.

Frequently live fish are used as bait. Examples of live bait-fish include, without limitation, hardtail, menhaden, pinfish, goggle-eye, pilchard or herring. There are several places used to attach the bait to the fish hook, each of which may result in a different swimming pattern of the bait-fish hook assembly in the water. Where to hook the bait-fish also depends on how strongly the current is running and whether the fisherman wants bait to swim up, down, out or in the current.

There are several ways to hook a live bait-fish to a fishhook.

For example, the bait-fish can be hooked in front of its dorsal fin, which forces a bait-fish to swim head-down and more frantically. These distress movements can draw strikes.

The bait-fish can be hooked through the nostrils. The bait-fish remain lively, with little risk of drowning, and it restricts less of the bait-fish's natural swimming action. When nostril-hooked, the bait swims at or near the surface, keeping pace with the boat's drift or slow-trolling rate. While in the water the fishhook-bait-fish assembly may “dart” around in the water, but the fishhook-bait-fish assembly will generally stay “up” in the water. This is ideal for surface live-baiting, such as when drifting offshore, around bait schools, and through inlets and passes for surface-oriented fish.

An alternative to nostril hooking is to jaw-hook a bait-fish. The hook is run under the lower jaw and out the upper jaw, or run up and out of the upper jaw only.

A bait-fish also can be hooked through the throat; without forward momentum, the fish cannot breathe, which forces a bait-fish to swim deeper.

A bait-fish can be hooked near its anal fin, which can make bait-fish swim away from a stationary platform, like a pier, jetty, bridge, beach or shoreline.

Lastly, the bait-fish can be hooked through its anal cavity and out its stomach, causing the bait-fish to wobble and dart head-up, as if it is injured.

To catch game fish, it is desirable to keep the bait-fish alive and frisky on the hook which can attract more strikes. The position behind the dorsal fin is often most secure, but causes the bait to tire out quickly and die fast. Inserting the fish hook through the lips makes it more likely that the fish will not drown quickly, but will cause it to move awkwardly through the water. Also, the fish may escape (come off) from the hook resulting in wasted bait during casting.

Inserting the hook through the nostrils will keep the bait alive as long as possible. However, when the bait-fish swims, moves, or twists in the water, it may slide along the bend of the fishhook, bringing the point or barb into proximity of the bait-fish's brain or eyes. In some cases, the point or barb can accidentally penetrate the bait-fish's brain or eyes, rendering the bait-fish useless as bait. It is important to keep the bait-fish's eyes undamaged, because when the bait-fish sees the game fish coming after it, the bait-fish will swim erratically causing the game fish to become more aggressive resulting in more bites. Currently available fishhooks have no mechanism to prevent the point or barb from pinch into the bait-fish's brain or eyes while the bait-fish swims or moves in the water.

A need therefore exists for improved fishhooks that can keep the bait-fish alive on the fishhook to attract more game fish, get more strikes, and increase fishing efficiency.

### BRIEF DESCRIPTION OF THE DRAWINGS

FIG. 1 shows a typical fishhook with the parts of the fishhook labeled.

FIG. 2 shows an exemplary configuration of a fish hook 10, a nostril-hooked bait-fish 20 and a fixedly placed barrier structure 30.

FIG. 3A shows a fishhook 40 comprising a fixedly placed barrier structure 50 fabricated during the manufacturing process of the fishhook. FIG. 3B shows that the nostril hooked bait-fish is positioned at the trough of the fishhook. The left eye faces the point 400 and the right eye faces the barrier structure 50.

FIG. 4A and FIG. 4B show a fishhook 40 comprising a fixedly placed barrier structure 50 that is vertically disposed in proximity to the lowest spot (trough) 407 of the bend (as shown in FIG. 4A) or the midpoint 408 of the bend (as shown in FIG. 4B) depending on the fishhook shape.

FIG. 5A depicts an embodiment of a barrier structure comprising a wedge or notch. The wedge or notch 62 is used to anchor the barrier structure 60 to the fishhook 10. At least one dimension of the wedge or notch 62 is slightly smaller than the thickness/diameter of the fishhook wire so that the barrier structure is tightly secured when the barrier structure comprising the wedge is attached to the fishhook. FIG. 5B shows a fishhook barrier structure assembly whereby the barrier structure is anchored to the fishhook utilizing the barrier structure's wedge 62. FIG. 5C shows an expanded view of the barrier structure 60. The attached portion of the fishhook is depicted in broken lines.

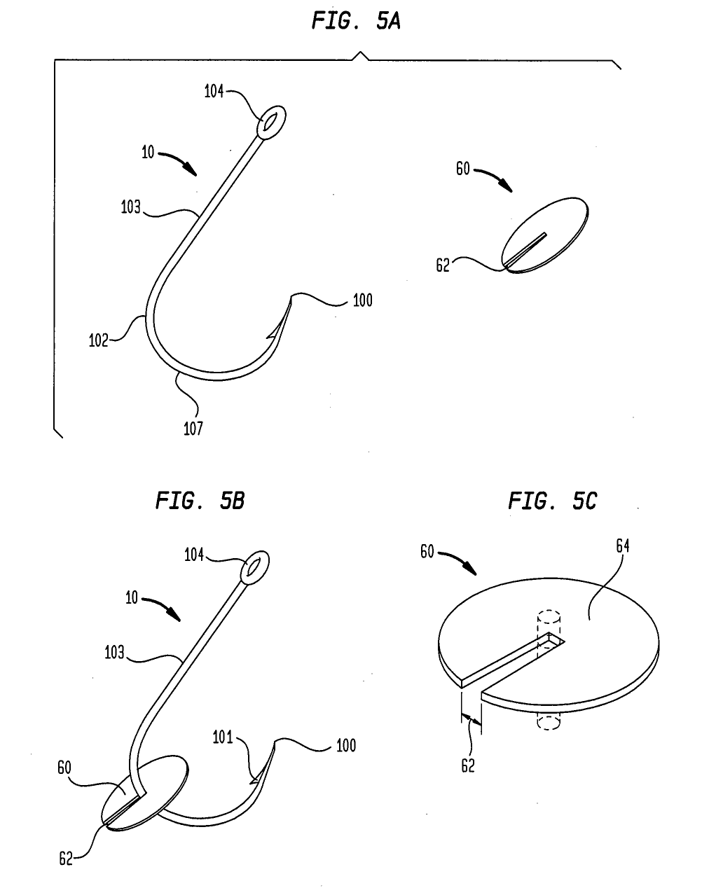

FIG. 6A depicts an embodiment of a barrier structure comprising a slit 601 and a hole 603. The slit 601 is used to slide the barrier structure onto the fishhook. The dimension of the hole 603 is slightly smaller than the thickness/diameter of the fishhook so that the barrier structure is tightly secure when the barrier structure is attached to the fishhook via the slit 601. FIG. 6B depicts an embodiment of a barrier structure comprising a slit 601, a hole 603 and a flap 602. The barrier structure is anchored to the fishhook utilizing the barrier structure's flap 602.

### SUMMARY OF THE INVENTION

According to one aspect, the described invention provides a fishhook for nostril-hooked live bait-fish comprising a point, a bend, a shank, an eye to secure the fishhook onto a fishing line, and a barrier structure, wherein the point is a sharp end that penetrates the bait-fish's mouth or flesh, the bend is a curved portion of the fishhook that extends downwards from the point and then upwards towards the shank, and the barrier structure is fixedly placed at a point along the bend of the fishhook, and wherein the fixedly placed barrier structure is effective to reduce injury to the bait-fish from a fishhook point when the bait-fish swims or moves while attached to the fishhook. According to one embodiment, the barrier structure is fixedly placed within about 0.05 mm to about 5 mm of a trough of the bend or the midpoint of the bend. According to another embodiment, the barrier structure is removable. According to another embodiment, the barrier structure is permanently affixed to the fishhook. According to another embodiment, the fishhook comprising the barrier structure is molded as one piece. According to another embodiment, the barrier structure is of a geometric shape. According to another embodiment, the barrier structure is fixedly placed within approximately 0.1% to about 10% of the bend length of the fishhook as measured from the fishhook trough. According to another embodiment, the barrier structure comprises one or more flat surface. According to another embodiment, the fishhook comprising the barrier structure further comprises a barb. According to another embodiment, the point is offset from the fishhook shank. According to another embodiment, the injury to the bait-fish from the fishhook point is to an eye or brain.

According to another aspect, the described invention provides a method for reducing injury to a nostril-hooked live bait-fish comprising hooking the live bait-fish with a fishhook comprising a point, a bend, a shank, an eye, and a barrier structure, wherein the point is a sharp end that penetrates the bait-fish's mouth or flesh, the bend is a curved portion of the fishhook that extends downwards from the point and then upwards towards the shank, and the barrier structure is fixedly placed at a point along the bend of the fishhook, and wherein the fixedly placed barrier structure is effective to reduce injury to the bait-fish from the point when the bait-fish swims or moves while attached to the fishhook. According to one embodiment of the method, the barrier structure is fixedly placed within about 0.05 mm to about 5 mm of a trough of the bend or the midpoint of the bend. According to another embodiment, the barrier structure is removable. According to another embodiment, the barrier structure is permanently affixed to the fishhook. According to another embodiment, the fishhook comprising the barrier structure is molded as one piece. According to another embodiment, the barrier structure is of a geometric shape. According to another embodiment, the barrier structure is fixedly placed within approximately 0.1% to about 10% of the bend length of the fishhook as measured from the fishhook trough. According to another embodiment, the barrier structure comprises one or more flat surface. According to another embodiment, the fishhook comprising the barrier structure further comprises a barb According to another embodiment, the point is offset from the fishhook shank. According to another embodiment, the injury to the bait-fish is to an eye or brain.

### DETAILED DESCRIPTION OF THE INVENTION

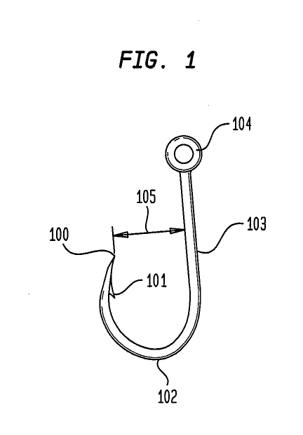

As shown in FIG. 1, a fishhook 10 comprises a point 100, an optional barb 101, a bend 102, a shank 103 and an eye 104. The point 100 is the sharp end that penetrates the fish's mouth or flesh. The optional barb 101 is a projection extending backwards from the point 100 and is used to secure the fish from unhooking. The eye 104 is the end of the hook that is used to secure the fishhook onto a fishing line. The bend 102 and shank 103 are the portions of the hook that connects the point 100 and the eye 104. The bend 102 is the curved portion extending downwards from the point 100 and then upwards towards the shank 103 and eye 104. The shank 103 is the portion between the bend 102 and the eye 104. Typically, the shank 103 is a substantially straight portion of the fishhook 10. The gap 105 is the distance between the shank 103 and the point 100. The term “fishhook trough” as used herein refers to the lowest point along the bend of the fishhook.

According to one aspect, the described invention provides a fishhook for live bait-fish comprising a barrier structure that is effective to prevent the bait-fish from being injured by the fishhook point when the bait-fish moves and twists while attached to the fishhook.

According to some embodiments, the barrier structure of the fishhook is effective to reduce movement of the fishhook forward in the nostrils of the bait-fish, and is effective to reduce pinching into the eyes or brain of the bait-fish.

According to some embodiments, the barrier structure comprises a center hole for inserting the fishhook point through the barrier structure and placing the barrier structure near the trough or midpoint of the bend of the fishhook.

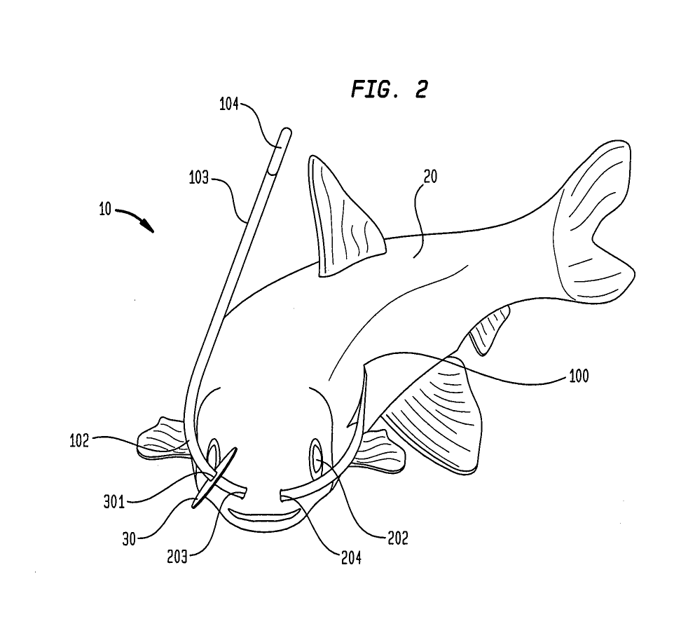

FIG. 2 depicts the configuration of a fish hook 10, a nostril-hooked bait-fish 20 and a fixedly placed barrier structure 30. The term “fixedly placed” as used herein refers to being fastened, attached, or set so as to be firm and not readily movable; stationary; or rigid.

According to some embodiments, the barrier structure is reusable and removable from the fishhook.

According to some such embodiments, the shank 103 and the part of the bend 102 proximal to the shank 103 are of a smaller diameter than the point 100 and the projection 101. According to some embodiments, the barrier structure comprises a center hole, the inside portion of which is threaded so that the barrier structure can slide down the shank 103, and comes to rest a desired distance along the fishhook trough at the bend 102. According to some such embodiments, threads complementary to the threads inside the barrier structure hole can be found along the bend at the desired distance. According to some such embodiments, the threads are at least 0.05 mm, 0.1 mm, 0.15 mm, 0.2 mm, 0.25 mm, 0.3 mm, 0.35 mm, 0.4 mm, 0.45 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, or 2.0 mm in length. The barrier structure can be screwed onto the fishhook by means of the matching threads inside the barrier structure hole and on the fishhook, so that the barrier structure stops at the end of the threading at the bend at the desired location and remains in a fixed position on the fishhook. According to some such embodiments, the size of the threading, the barrier structure or both can be changed so that the barrier structure stops or comes to rest at different points along the bend, depending on the size of the bait-fish and the fishhook.

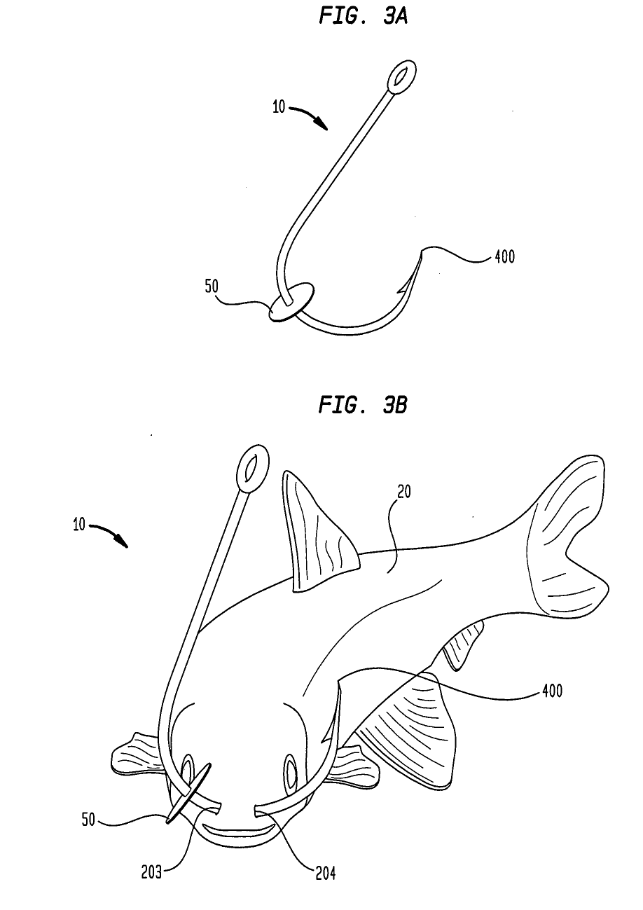

According to some embodiments, the barrier structure is permanently affixed to the fishhook. According to some such embodiments, the fishhook comprising the barrier structure is molded as one piece. FIG. 3A shows a fishhook 40 comprising a one-piece, fixedly placed barrier structure 50 fabricated during the manufacturing process of the fishhook. FIG. 3B shows one embodiment in which a nostril hooked bait-fish is positioned at the trough of the fishhook, with the left eye of the bait-fish facing the point 400 and the right eye facing the barrier structure 50. According to some embodiments, the barrier structure is permanently placed on the fishhook by means of a hard stop. According to some such embodiments, the hard stop is a snap, a screw, or some other hard stop.

According to some embodiments, a plurality of fishhooks comprising the barrier structure is provided. According to some such embodiments, for a given fishhook, the barrier structure is fixedly placed at a defined point along the bend in close proximity (meaning very near) to the trough of the bend or the midpoint of the bend. The end result is a selection of fishhooks with barrier structures fixedly placed at different points along the bend of the fishhook so as to accommodate a selection of bait-fish.

According to some embodiments, the barrier structure is a structure of any geometric shape, e.g., a triangle, a square, a line, a rectangle, a polyhedral, a circle, a cylinder or another irregular shape.

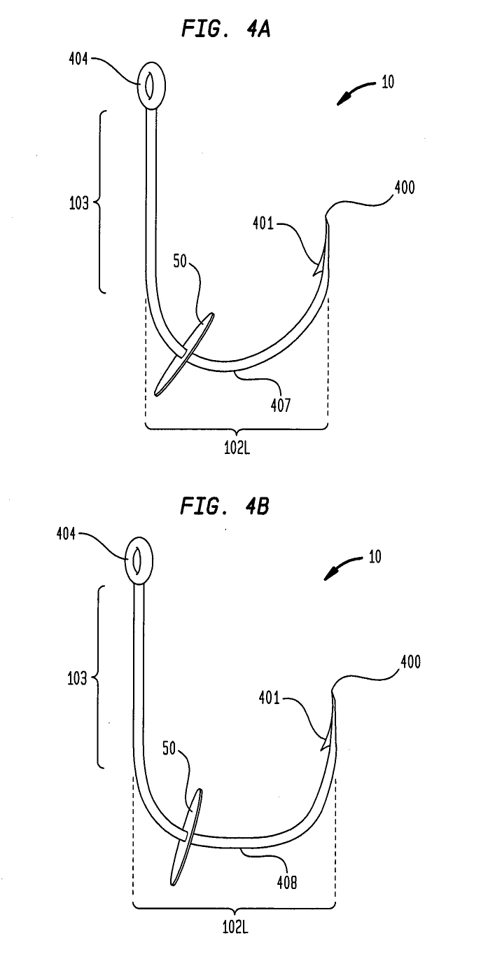

FIG. 4A and FIG. 4B show a fishhook 40 comprising a fixedly placed barrier structure 50 that is vertically disposed in proximity to the lowest spot (trough) 407 of the bend (as shown in FIG. 4A) or the midpoint 408 of the bend (as shown in FIG. 4B) depending on the fishhook shape. Although a small round barrier structure is depicted, the size, shape, thickness and position of the barrier structure is a function of the size of the fishhook and the size of the intended bait-fish.

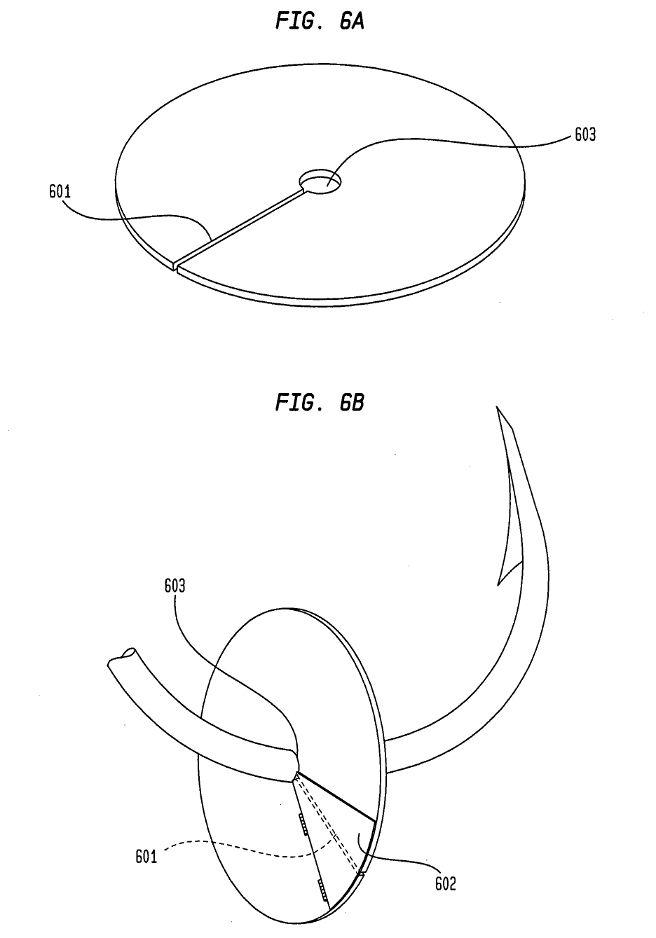

FIG. 6A depicts an embodiment of a barrier structure comprising a slit 601 and a hole 603. The slit 601 is used to slide the barrier structure onto the fishhook. The dimension of the hole 603 is slightly smaller than the thickness/diameter of the fishhook so that the barrier structure is tightly secure when the barrier structure is attached to the fishhook via the slit 601.

FIG. 6B depicts an embodiment of a barrier structure comprising a slit 601, a hole 603 and a flap 602. The barrier structure is anchored to the fishhook utilizing the barrier structure's flap 602. Although a small round barrier structure is depicted, the size, shape, thickness and position of the barrier structure is a function of the size of the fishhook and the size of the intended bait-fish.

According to some embodiments, the barrier structure is fixedly placed within approximately 0.05 mm-5.0 mm of the trough 407 or the midpoint 408 of the fishhook bend. According to some embodiments, and depending on the size of the fishhook, and the size of the bait-fish, the barrier structure is fixedly placed within about 0.05 mm, 0.1 mm, 0.15 mm, 0.2 mm, 0.25 mm, 0.3 mm, 0.35 mm, 0.4 mm, 0.45 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm. or 5 mm of the fishhook trough.

According to some embodiments, the barrier structure is fixedly placed within approximately 0.1%-10% of the bend length (indicated as 102L) of the fishhook as measured from the fishhook trough. According to some such embodiments, the barrier structure is fixedly placed within about 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9% or 10% of the length of the fishhook from the fishhook trough.

According to one embodiment, the thickness of the barrier structure ranges from the same as the thickness of the fishhook to a multiple of the thickness of the fishhook. According to some embodiments, the multiple is at least 1.5, 2, 3, 4, 5, 6, 7, 8, 9, or 10 times the thickness of the fishhook.

According to some embodiments, the barrier structure comprises a porous material.

According to some embodiments, the barrier structure comprises a solid material. According to some embodiments, the solid material is a metal. According to some embodiments, the solid material is a nonmetal.

According to some embodiments, the barrier structure comprises a thermally responsive substance, e.g., a thermoplastic, meaning a material that becomes softer and therefore pliable or moldable when heated above a certain temperature and harder when cooled. A thermoplastic material may be able to undergo such cycles indefinitely without damage. Exemplary thermoplastics include, without limitation, moldable thermoplastics, heat-shrink thermoplastics and thermoplastic polymer resins. A non-limiting example of a moldable thermoplastic includes InstaMorph®. Heat-shrink thermoplastics include, without limitation, polyolefins. Exemplary polyolefins include polyethylene, polypropylene, polymethylpentene, polybutene-1 and the like. Thermoplastic polymer resins include, but are not limited to, polyethylene terephthalate (PET).

According to some embodiments, the barrier structure comprises a shape-memory alloy, meaning a mixture of two or more elements, one of which must be a metal, to form a macroscopically homogeneous metallic product that “remembers” its original shape. A shape-memory alloy can undergo significant plastic deformation, then be returned to its original shape upon being heated. Non-limiting examples of shape-memory alloys include nickel titanium, also known as nitinol; copper-aluminum-nickel, copper-zinc-aluminum, and iron-manganese-silicon alloys.

According to some embodiments, the barrier structure comprises a superplastic formable metal alloy. “Superplastic deformation” as used herein describes a condition in which a material can be extended to very large strains. The main requirement for attaining superplasticity is to avoid plastic instability and fracture during elongation. According to some embodiments, for superplasticity, the material can be processed to a grain size smaller than 10 μm and deformed at a moderate strain rate at high temperatures such that grain boundary sliding makes a large contribution to the overall tensile strain. According to some embodiments, the superplastic formable metal alloy is an aluminum alloy.

According to some embodiments, the barrier structure comprises a bulk metallic glass or bulk amorphous alloy with a unique amorphous atomic structure that provides very high yield strength and that can retain its original shape after undergoing very high loads and stress. This alloy is available in “as-cast” form and does not require any thermos-mechanical operations.

According to some embodiments, the barrier structure comprises wire. According to some such embodiments the barrier structure is hollow. According to some such embodiments, the barrier structure is a solid structure.

According to some embodiments, the barrier structure comprises at least one flat surface.

According to some embodiments, the barrier structure comprises a concave side designed to be positioned adjacent to the bait-fish's head.

According to some embodiments, the barrier structure comprises a flap. FIG. 6B depicts an embodiment of a barrier structure comprising a flap (602). The barrier structure is anchored to the fishhook utilizing the barrier structure's flap (602). According to some such embodiments, the flap is a self-sealing material (e.g., one that adheres to itself). According to some such embodiments, the flap is not a self-sealing material.

According to some embodiments, the barrier structure comprises a material whose density is less than that of the fishhook. According to some embodiments, the barrier structure comprises a material whose density is greater than that of the fishhook. According to some embodiments, the barrier structure and the fishhook are fabricated of the same material.

According to some embodiments, the barrier structure is bonded to the fishhook by an attachment means, e.g., welding. According to some embodiments, the fishhook comprising the barrier structure is a molded fishhook.

According to some embodiments, the fishhook comprising the barrier structure comprises a single point, a single barb, a single bend, and a single shank. According to some embodiments, the fishhook comprising the barrier structure comprises a plurality of points, a plurality of barbs, a plurality of bends and a plurality of shanks. According to some embodiments, the fishhook comprising the barrier structure is barbless.

According to some embodiments, the fishhook comprising the barrier structure comprises a fishhook point that is offset from the fishhook shank. According to some such embodiments, the fishhook point is offset to the left. According to some such embodiments, the fishhook point is offset to the right. According to some such embodiments, the offset is at least 1°, 2°, 3°, 4°, 5°, 6°, 7°, 8°, 9°, 10°, 15°, 20°, 25°, 30°, 35°, 40°, 45°, or 50° from the hook shank.

According to another aspect, the described invention provides a methods for reducing injury to a nostril-hooked live bait-fish comprising hooking the bait-fish with a fishhook comprising a point, a bend, a shank, an eye, optionally a barb, and a barrier structure that is effective to prevent the bait-fish from being injured by the fishhook point when the bait-fish moves and twists while attached to the fishhook.

According to some embodiments, the barrier structure component of the fishhook is effective to reduce movement of the fishhook forward in the nostrils of the bait-fish, and is effective to reduce pinching into the eyes or brain of the bait-fish.

FIG. 2 depicts the configuration of a fish hook 10, a nostril-hooked bait-fish 20 and a fixedly placed barrier structure 30.

According to some embodiments, the barrier structure is reusable and removable from the fishhook.

According to some such embodiments, the shank 103 and the part of the bend 102 proximal to the shank 103 are of a smaller diameter than the point 100 and the projection 101. According to some embodiments, the barrier structure comprises a center hole, the inside portion of which is threaded so that the barrier structure can slide down the shank 103, and comes to rest a desired distance along the fishhook trough at the bend 102. According to some such embodiments, threads complementary to the threads inside the barrier structure hole can be found along the bend at the desired distance. According to some such embodiments, the threads are at least 0.05 mm, 0.1 mm, 0.15 mm, 0.2 mm, 0.25 mm, 0.3 mm, 0.35 mm, 0.4 mm, 0.45 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, or 2.0 mm in length. The barrier structure can be screwed onto the fishhook by means of the matching threads inside the barrier structure hole and on the fishhook, so that the barrier structure stops at the end of the threading at the bend at the desired location and remains in a fixed position on the fishhook. According to some such embodiments, the size of the threading, the barrier structure or both can be changed so that the barrier structure stops or comes to rest at different points along the bend, depending on the size of the bait-fish and the fishhook.

According to some embodiments, the barrier structure is permanently affixed to the fishhook. According to some such embodiments, the fishhook comprising the barrier structure is molded as one piece. FIG. 3A shows a fishhook 40 comprising a one-piece, fixedly placed barrier structure 50 fabricated during the manufacturing process of the fishhook. FIG. 3B shows one embodiment in which a nostril hooked bait-fish is positioned at the trough of the fishhook, with the left eye faces the point 400 and the right eye faces the barrier structure 50. According to some embodiments, the barrier structure is permanently placed on the fishhook by a hard stop. According to some such embodiments, the hard stop is a snap, a screw or some other hard stop.

According to some embodiments, a plurality of fishhooks comprising the barrier structure is provided. According to some such embodiments, for a given fishhook, the barrier structure is fixedly placed at a defined point along the bend. The end result is a selection of fishhooks with barrier structures fixedly placed at different points along the bend of the fishhook so as to accommodate a selection of bait-fish.

According to some embodiments, the barrier structure is a structure of any geometric shape, e.g., a triangle, a square, a line, a rectangle, a polyhedral, a circle, a cylinder or another irregular shape.

FIG. 4A and FIG. 4B show a fishhook 40 comprising a fixedly placed barrier structure 50 that is vertically disposed in proximity to the lowest spot (trough) 407 of the bend (as shown in FIG. 4A) or the midpoint 408 of the bend (as shown in FIG. 4B) depending on the fishhook shape. Although a small round barrier structure is depicted, the size, shape, thickness and position of the barrier structure is a function of the size of the fishhook and the size of the intended bait-fish.

FIG. 6A depicts an embodiment of a barrier structure comprising a slit 601 and a hole 603. The slit 601 is used to slide the barrier structure onto the fishhook. The dimension of the hole 603 is slightly smaller than the thickness/diameter of the fishhook so that the barrier structure is tightly secure when the barrier structure is attached to the fishhook via the slit 601.

FIG. 6B depicts an embodiment of a barrier structure comprising a slit 601, a hole 603 and a flap 602. The barrier structure is anchored to the fishhook utilizing the barrier structure's flap 602. Although a small round barrier structure is depicted, the size, shape, thickness and position of the barrier structure is a function of the size of the fishhook and the size of the intended bait-fish.

According to some embodiments, the barrier structure is fixedly placed within approximately 0.05 mm-5.0 mm of the trough 407 or the midpoint 408 of the fishhook bend. According to some embodiments, and depending on the size of the fishhook, and the size of the bait-fish, the barrier structure is fixedly placed within about 0.05 mm, 0.1 mm, 0.15 mm, 0.2 mm, 0.25 mm, 0.3 mm, 0.35 mm, 0.4 mm, 0.45 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm. or 5 mm of the fishhook trough.

According to some embodiments, the barrier structure is fixedly placed within approximately 0.1%-10% of the bend length (indicated as 102L) of the fishhook as measured from the fishhook trough. According to some such embodiments, the barrier structure is fixedly placed within about 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9% or 10% of the length of the fishhook as measured from the fishhook trough.

According to one embodiment, the thickness of the barrier structure ranges from the same as the thickness of the fishhook to a multiple of the thickness of the fishhook. According to some embodiments, the multiple is at least 1.5, 2, 3, 4, 5, 6, 7, 8, 9, or 10 times the thickness of the fishhook.

According to some embodiments, the barrier structure comprises a porous material.

According to some embodiments, the barrier structure comprises a solid material. According to some embodiments, the solid material is a metal. According to some embodiments, the solid material is a nonmetal.

According to some embodiments, the barrier structure comprises a thermally responsive substance, e.g., a thermoplastic, meaning a material that becomes softer and therefore pliable or moldable when heated above a certain temperature and harder when cooled. A thermoplastic material may be able to undergo such cycles indefinitely without damage. Exemplary thermoplastics include moldable thermoplastics, heat-shrink thermoplastics and thermoplastic polymer resins. A non-limiting example of a moldable thermoplastic includes InstaMorph®. Heat-shrink thermoplastics include, but are not limited to, polyolefins. Exemplary polyolefins include polyethylene, polypropylene, polymethylpentene, polybutene-1 and the like. Thermoplastic polymer resins include, but are not limited to, polyethylene terephthalate (PET).

According to some embodiments, the barrier structure comprises a shape-memory alloy. A shape-memory alloy is an alloy that can undergo significant plastic deformation, then be returned to its original shape upon being heated. A non-limiting example of a shape-memory alloy is nickel titanium, also known as nitinol.

According to some embodiments, the barrier structure comprises a superplastic formable metal alloy. “Superplastic deformation” as used herein describes a condition in which a material can be extended to very large strains. The main requirement for attaining superplasticity is to avoid plastic instability and fracture during elongation. According to some embodiments, for superplasticity, the material can be processed to a grain size smaller than 10 μm and deformed at a moderate strain rate at high temperatures such that grain boundary sliding makes a large contribution to the overall tensile strain. According to some embodiments, the superplastic formable metal alloy is an aluminum alloy.

According to some embodiments, the barrier structure comprises a bulk metallic glass or bulk amorphous alloy with a unique amorphous atomic structure that provides very high yield strength and that can retain its original shape after undergoing very high loads and stress. This alloy is available in “as-cast” form and does not require any thermos-mechanical operations.

According to some embodiments, the barrier structure comprises wire. According to some such embodiments the barrier structure is hollow. According to some such embodiments, the barrier structure is a solid structure.

According to some embodiments, the barrier structure comprises at least one flat surface.

According to some embodiments, the barrier structure comprises a concave side designed to be positioned adjacent to the bait-fish's head.

According to some embodiments, the barrier structure comprises a flap. FIG. 6B depicts an embodiment of a barrier structure comprising a flap (602). The barrier structure is anchored to the fishhook utilizing the barrier structure's flap (602). According to some such embodiments, the flap is a self-sealing material (e.g., adheres to itself). According to some such embodiments, the flap is not a self-sealing material.

According to some embodiments, the barrier structure comprises a material whose density is less than that of the fishhook. According to some embodiments, the barrier structure comprises a material whose density is greater than that of the fishhook. According to some embodiments, the barrier structure and the fishhook are fabricated of the same material.

According to some embodiments, the barrier structure is bonded to the fishhook by an attachment means, e.g., welding. According to some embodiments, the fishhook comprising the barrier structure is a molded fishhook.

According to some embodiments, the fishhook comprising the barrier structure comprises a single point, optionally a single barb, a single bend, and a single shank. According to some embodiments, the fishhook comprising the barrier structure comprises a plurality of points, optionally a plurality of barbs, a plurality of bends and a plurality of shanks. According to some embodiments, the fishhook comprising the barrier structure is barbless.

According to some embodiments, the fishhook point of the fishhook comprising the barrier structure is offset from the hook shank. According to some such embodiments, the fishhook point is offset to the left. According to some such embodiments, the fishhook point is offset to the right. According to some such embodiments, the offset is at least 1°, 2°, 3°, 4°, 5°, 6°, 7°, 8°, 9°, 10°, 15°, 20°, 25°, 30°, 35°, 40°, 45°, or 50° from the hook shank.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges which may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials have been described. All publications mentioned herein are incorporated herein by reference to disclose and described the methods and/or materials in connection with which the publications are cited.

It must be noted that as used herein and in the appended claims, the singular forms “a”, “and”, and “the” include plural references unless the context clearly dictates otherwise.

The publications discussed herein are provided solely for their disclosure prior to the filing date of the present application and each is incorporated by reference in its entirety. Nothing herein is to be construed as an admission that the present invention is not entitled to antedate such publication by virtue of prior invention. Further, the dates of publication provided may be different from the actual publication dates which may need to be independently confirmed.

While the present invention has been described with reference to the specific embodiments thereof it should be understood by those skilled in the art that various changes may be made and equivalents may be substituted without departing from the true spirit and scope of the invention. In addition, many modifications may be made to adopt a particular situation, material, composition of matter, process, process step or steps, to the objective spirit and scope of the present invention. All such modifications are intended to be within the scope of the claims appended hereto.

1. A fishhook comprising a point, a bend, a shank, an eye, and a barrier structure,
wherein
the point is a sharp end that is effective to penetrate a mouth, nostril, flesh, or a combination thereof of a live bait-fish
the bend is a curved portion of the fishhook that extends downwards from the point and then upwards towards the shank,
the eye is effective to secure the fishhook onto a fishing line; and
the barrier structure is fabricated during manufacture as one piece with the fish hook and fixedly placed at a point along the bend of the fishhook,
wherein the fixedly placed barrier structure is effective
to maintain the bait-fish in a position along the shank of the fishhook that facilitates a natural free swimming motion of the baitfish;
to reduce injury to the bait-fish from the point of the fishhook when the bait-fish swims or moves while attached to the fishhook; and
to keep the hook of the fishhook point in a proper position to hook a fish when the fish strikes.

2. The fishhook according to claim 1, wherein the barrier structure is fixedly placed within about 0.05 mm to about 5 mm of a trough of the bend or a midpoint of the bend.

3. (canceled)

4. (canceled)

5. (canceled)

6. The fishhook according to claim 1, wherein the barrier structure is of a geometric shape.

7. The fishhook according to claim 1, wherein the barrier structure is fixedly placed within approximately 0.1% to about 10% of a bend length of the fishhook as measured from a fishhook trough.

8. The fishhook according to claim 1, wherein the barrier structure comprises one or more flat surfaces.

9. The fishhook according to claim 1, wherein the fishhook comprising the barrier structure further comprises a barb.

10. The fishhook according to claim 1, wherein the point is offset from the fishhook shank.

11. The fishhook according to claim 1, wherein the injury to the bait-fish from the fishhook point is to an eye or brain.

12. A method for reducing injury to a live bait-fish comprising
(a) Providing a fishhook comprising a point, a bend, a shank, an eye, and a barrier structure,
wherein
the point is a sharp end that is effective to penetrate a mouth, nostril, flesh or a combination thereof of the baitfish,
the bend is a curved portion of the fishhook that extends downwards from the point and then upwards towards the shank,
the eye is effective to secure the fishhook onto a fishing line;
and the barrier structure, which is fabricated during manufacture as one piece with the fishhook, is fixedly placed at a point along the bend of the fishhook, and
(b) hooking the live bait-fish with the fishhook, wherein the fixedly placed barrier structure is effective
to maintain the bait-fish in a position along the shank of the fishhook that facilitates a natural free swimming motion of the baitfish;
to reduce injury to the bait-fish from the point when the bait-fish swims or moves while attached to the fishhook; and
to keep the hook pointed in a proper position to hook a fish when the fish strikes.

13. The method according to claim 12, wherein the barrier structure is fixedly placed within about 0.05 mm to about 5 mm of a trough of the bend or a midpoint of the bend.

14. (canceled)

15. (canceled)

16. (canceled)

17. The method according to claim 12, wherein the barrier structure is of a geometric shape.

18. The method according to claim 12, wherein the barrier structure is fixedly placed within approximately 0.1% to about 10% of a bend length of the fishhook as measured from a fishhook trough.

19. The method according to claim 12, wherein the barrier structure comprises one or more flat surfaces.

20. The method according to claim 12, wherein the fishhook comprising the barrier structure further comprises a barb.

21. The method according to claim 12, wherein the point is offset from the fishhook shank.

22. The method according to claim 12, wherein the injury to the bait-fish is to an eye or brain.
